(19) United States
(12) Patent Application Publication
(10) Pub. No.: US 2008/0118328 A1
(43) Pub. Date: May 22, 2008

(54) Suspension fastener

(76) Inventor: Yung-Chia Chen, Taipei (TW)

Correspondence Address: Thomas E. Sisson;Jackson Walker, LLP, Suite 2400, 112 E. Pecan, San Antonio, TX, 78205, US

(21) Appl. No.: 11/602,803

(22) Filed: Nov. 21, 2006

(51) Int. Cl. F16B 39/00

(52) U.S. Cl. 411/337

(57) ABSTRACT

A suspension fastener has a bolt and a shaft. The bolt has a tip formed in a first end thereof and a revolving portion formed in a second end thereof. The shaft has a hole formed in a first end thereof and corresponding to the revolving portion. A shank is formed on a second end of the shaft and a recess is formed in a free end of the shank. A nut is fastened on the shank. The shaft extends through a furniture and is engaged with the bolt to suspend the furniture on the wall.

### BACKGROUND OF THE INVENTION

1. Field of the Invention

The present invention relates to a suspension fastener, and more particular to a suspension fastener for suspending furniture.

2. Description of the Related Art

Suspended furniture is used widely for decoration, and conventional fasteners are use to securely mount the suspended furniture on a wall.

However, the conventional fastener and the furniture are not integrity formed together thereby generating less aesthetics.

Therefore, the invention provides a suspension fastener to mitigate or obviate the aforementioned problems.

### SUMMARY OF THE INVENTION

The main objective of the present invention is to provide a suspension fastener which can suspend a furniture with aesthetics.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a suspension fastener in according with the present invention;

FIG. 2 is a side plane view in partial section of the suspension fastener in FIG. 1 with furniture; and

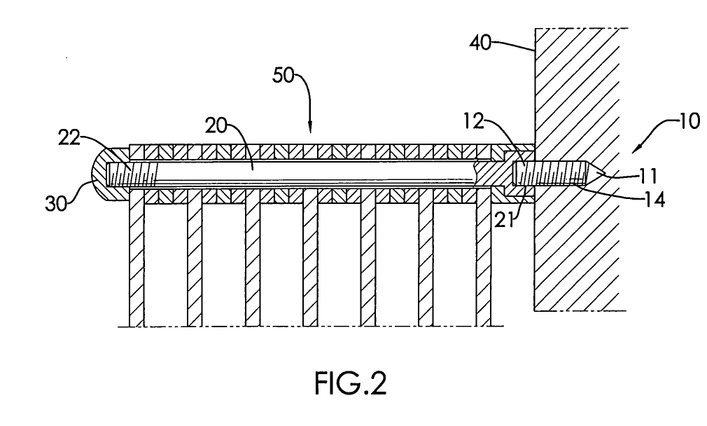

FIG. 3 is a perspective view of the suspension fastener in FIG. 1 with the furniture.

### DETAILED DESCRIPTION OF THE PREFERRED EMBODIMENT

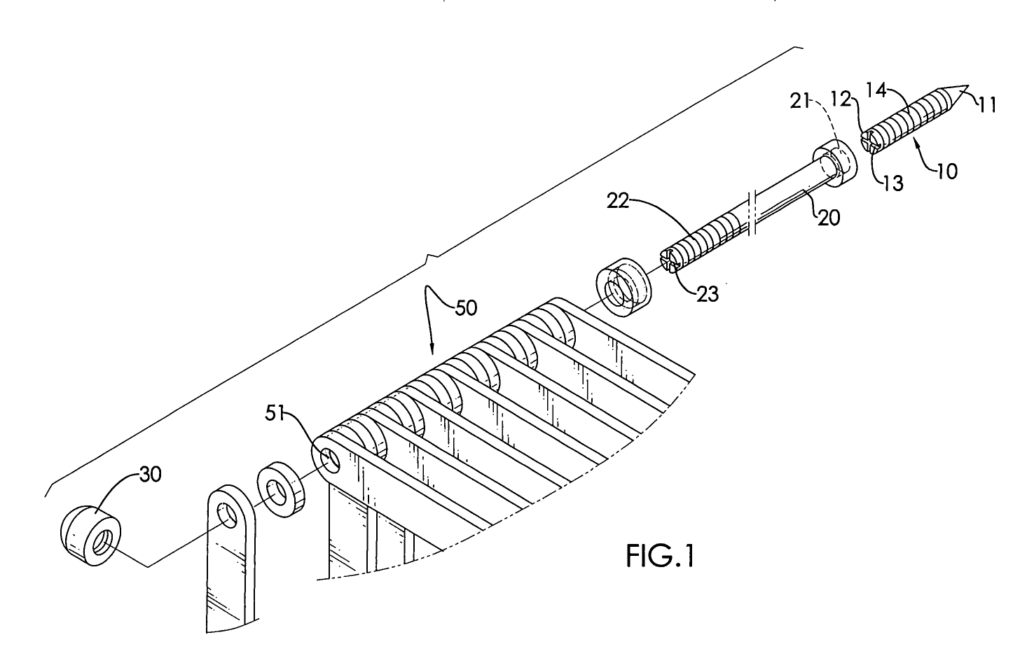

With reference to FIG. 1, a suspension fastener has a bolt (10), a shaft (20) and a nut (30).

The bolt (10) has a tip (11) formed in a first end thereof and a revolving portion (12) formed in a second end thereof. A free end of the revolving portion (12) has a cross groove (13). A thread (14) is formed around an outer surface of the bolt (10).

The shaft (20) has a threaded hole (21) formed in a first end thereof and corresponding to the thread (14). A shank (22) is formed on a second end of the shaft (20) and a recess (23) is formed in a free end of the shank (22). The recess (23) has a cross shape.

The nut (30) is screwed with the shank (22).

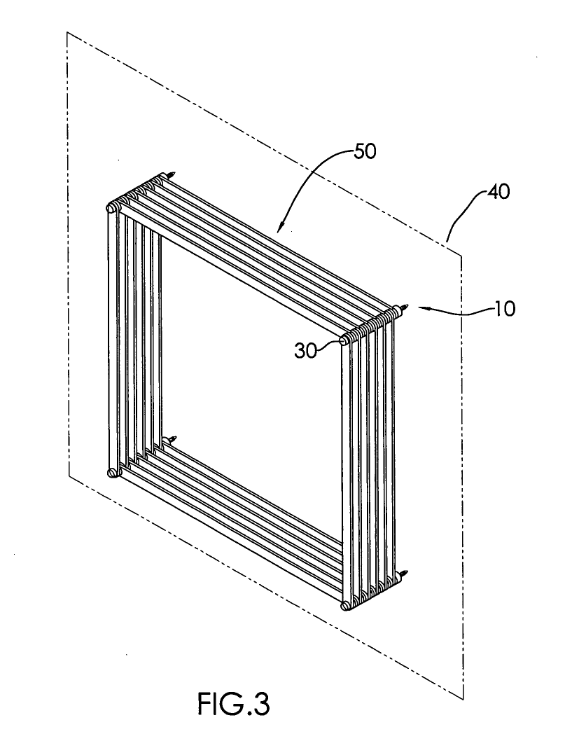

With reference to FIGS. 1 and 3, the tip (11) is inserted into a wall by rotating the revolving portion (12) with a tool so that the bolt (10) is fixed in the wall. The threaded hole (21) is screwed with the thread (14), and the shaft (20) extends through an orifice (51) in a furniture (50). Furthermore, the nut (30) is fastened to the shank (22). Hence, the furniture (50) is suspended on the wall with fasteners.

Additionally, the furniture (50) can be extended by the shaft (20) at first. The shank (22) is rotated with a tool engaging with the recess (23) so that the shaft (20) is screwed onto the bolt (10). Then, the nut (30) is coupled with the shank (22) whereby the furniture (50) can also be suspended on the wall.

Hence, the shaft (20) is mounted in the furniture (20) so that the appearance of the furniture is aesthetic.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A suspension fastener comprising:
a bolt having
a tip formed in a first end thereof,
a revolving portion formed in a second end thereof;
a shaft having
a hole formed in a first end thereof and corresponding to the revolving portion; and
a nut engaged with a second end of the shaft.

2. The suspension fastener as claimed in claim 1, wherein a free end of the revolving portion has a groove and a thread is formed in an outer surface of the bolt, the shaft has a threaded hole formed in a first end thereof and corresponding to and screwed with the thread, a shank is formed on a second end of the shaft and a recess is formed in a free end of the shank.

3. The suspension fastener as claimed in claim 1, wherein the recess and the groove respectively have a cross shape.
